(19) United States
(12) Patent Application Publication
(10) Pub. No.: US 2002/0091530 A1
(43) Pub. Date: Jul. 11, 2002

(54) Interactive voice response system and method having voice prompts with multiple voices for user guidance

(76) Inventor: Erin M. Panttaja, Somerville, MA (US)

Correspondence Address: STAAS & HALSEY LLP, 700 11TH STREET, NW, SUITE 500, WASHINGTON, DC, 20001, US

(21) Appl. No.: 09/754,084

(22) Filed: Jan. 5, 2001

(51) Int. Cl. G10L 11/00; G10L 21/00

(52) U.S. Cl. 704/275

(57) ABSTRACT

A method and system for a voice controlled apparatus is capable of playing a single audio voice passage to a user of the voice controlled apparatus. The single audio voice passage has at least first and second different voices which invite a response from the user. The second voice indicates to the user the type of response which is invited from the user. The method and system are applicable to any type of voice controlled apparatus including voice messaging systems, personal assistants, and robots.

### BACKGROUND OF THE INVENTION

1. Field of the Invention

The present invention is directed to a system and method which plays a single audio voice passage having at least first and second voices, to a user to invite a response from the user, and particularly to a voice controlled system and method which includes such features.

2. Description of the Related Art Designers of automated systems face a problem in instructing users of the system. This problem is particularly difficult when the constraints of the system make the interaction with the user unclear to the user. For example, a manual for a computer system might include the statement:

### “When you are finished, press enter.”

An experienced user would understand this command immediately, but the meaning may not be obvious to a beginner. In particular, a beginner might choose to type the word “enter” in response to this instruction. One way to avoid this misunderstanding in written communication is through the use of multiple fonts. For example, a clearer instruction might be:

### “When you are finished, press ENTER.”

In the above example, the difference in fonts instructs the reader to look for the ENTER key, thereby avoiding possible confusion with respect to the instruction. The use of this approach makes it easier for users to follow instructions.

Certain teaching systems have been set up to use two voices, with one voice providing instructions and another voice telling the user what to say. Examples of such teaching systems include systems for helping people with speech impediments, and systems which provide foreign language instruction.

In 1983, Chris Schmandt of MIT built a system referred to as “Voiced Mail,” which was used to read e-mail over the phone. This system used different voices for the system and for the e-mail which was read. As a result, users could clearly understand whether a given phrase was being “said” by the system, or was a part of an e-mail message, thereby avoiding confusion on the part of the user.

In the early 1990s, Mr. Schmandt created a system known as Phoneshell, in which callers call into an automated system and use their telephone keys to generate DTMF tones to access various services such as news recordings and voice and e-mail messages. In this system, the speech rate was varied when reciting digit strings in an address book look-up. Specifically, phone numbers were spoken more slowly than other information. An example of this type of statement is as follows:

“the home number is <slow down> 555-1212 <speed up> and

the work number is <slow down> 936-1234 <speed up>.”

Thus, in the above system, statements including phone numbers were spoken at a varied speed because the user can understand spoken text quickly, but needs additional time when it is necessary to write down a telephone number.

In 1996, Mr. Schmandt and Matt Marx developed a system referred to as “Mailcall.” This system employed a similar slow down technique while reading the name of the sender of a message. This was done for similar reasons, on the basis that the understanding of the name of the sender is a cognitively demanding task because the set of names is open and potentially quite large. As a result, natural language redundancy is not available to aid intelligibility.

In current IVR (interactive voice response) systems, speech recognition is not sufficiently accurate to enable a user to give unlimited types of commands. Thus, it is necessary to instruct the user using voice recordings or prompts. These prompts contain a combination of instructions, system information, user-requested data and examples of actual commands which the system will understand. In most systems, these prompts are recorded by a single voice talent, or a combination of a voice talent and computer generated speech (TTS) An example of such a single voice prompt is:

“To hear your address book options, say “help address book.””

Because the user cannot clearly distinguish between the portion of the prompt “help address book” and the remainder of the prompt, there can be some confusion and the user may be unclear as to exactly what they should say. An example of a combined prompt is “message received from JOHN JONES.” The name John Jones is spoken using TTS, as there is no voice recording, but in this case, the use of a second voice can be confusing. Thus, there is a need in the art for improved prompts in voice controlled systems such as IVR systems, which will make it clear to the user precisely how they should respond to a particular prompt.

### SUMMARY OF THE INVENTION

The present invention is directed to a method and system which overcomes the above-described disadvantages of current interactive voice response systems and other voice controlled systems by emphasizing the difference between general instructions being provided, and the actual input or words with which a user must respond in order to have the system take the appropriate action.

The present invention achieves the above results by providing a method and system which plays a single audio voice passage to a user to invite a response from the user. The single audio voice passage has at least first and second different voices. For example, two voices may be used within a single prompt in order to emphasize the difference between instructions and the actual input or words with which a user must respond. This clarity is particularly important in noisy situations or during long help sequences. The function of most grammar items is clear from the wording, and the user need only listen for the voice which provides the examples.

The use of multiple voices provides even greater clarity than the use of multiple fonts. Rather than merely highlighting a word, which the user can then translate into a key to press or a menu to select, the features of the present invention allow the user to hear the desired command and then repeat it back to the system using the same modality, with no translation required.

These, together with other features and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of an information server in a distributed information services system, in which the features of the present invention may be implemented;

FIG. 2 is a flowchart illustrating how a single voice passage or prompt is recorded and stored using at least two different voices;

FIG. 3 is a flowchart illustrating how a spliced voice prompt is played to a user to invite a user response in accordance with the present invention; and

FIG. 4 is a flowchart illustrating how two different portions of a prompt are concatenated together and played to a user to invite a response from the user in accordance with the present invention.

### DESCRIPTION OF THE PREFERRED EMBODIMENTS

The method and system of the present invention are directed to playing a single audio voice passage to a user. The single audio voice passage has at least first and second different voices which invite a response form the user. Specifically, the first voice provides the system portion of the message and the second voice indicates the type of response that is expected from the user.

The inventor has found that in practice, users of voice interfaces tend to repeat phases that they know will work, even if other variations are possible. Learning how to phrase requests is one of the most difficult parts of learning to use the system. Hearing the suggested user input in a different voice can help to highlight the appropriate response to make it easier for the user to recall at a later time. In addition, this feature enables the prompts to be shortened. For example, a typical one voice prompt might read as follows:

“In your address book, you can call a number by saying “call 555-1212,” or call someone in your address book with “call John Jones,” or say “add a name to my address book.””

In contrast, in accordance with the two voice method and system of the present invention, the following shorter prompt can be used:

“in your address book, use “CALL 555-1212,” or “ADD A NAME TO MY ADDRESS BOOK,” or for someone in your address book, “CALL JOHN JONES”.” (where the second voice is illustrated in all capital letters)

The latter version in accordance with the present invention is shorter and therefore faster, but is also clearer due to the use of two voices in the six distinct audio segments.

The present invention is directed to a method and system which are used with a voice controlled system or apparatus. For example, the method and system of the present invention could be used in any voice controlled product such as in an automobile or a robot. In a preferred embodiment of the present invention, the invention is implemented in conjunction with the Tel@Go™ application which is manufactured and sold by Comverse Network Systems, Inc. of Wakefield, Mass. for use in conjunction with the TRILOGUE™ INfinity™ platform manufactured and sold by Comverse Network Systems, Inc. of Wakefield, Mass. The Tel@Go™ application is a personal assistant application which employs interactive voice response features. In particular, Tel@Go™ is an application which provides a personal assistant that performs messaging, address book, calendar and web services, and various types of information services for a subscriber. For example, if a user speaks to the system and says, “Tell me the weather,” Tel@Go will look up the weather for the user's home city on the web, fetch it and play it back to the user in either text or speech. In addition, if the user says “What is the NPR news?” Tel@Go will play back an audio file of the current news from NPR.

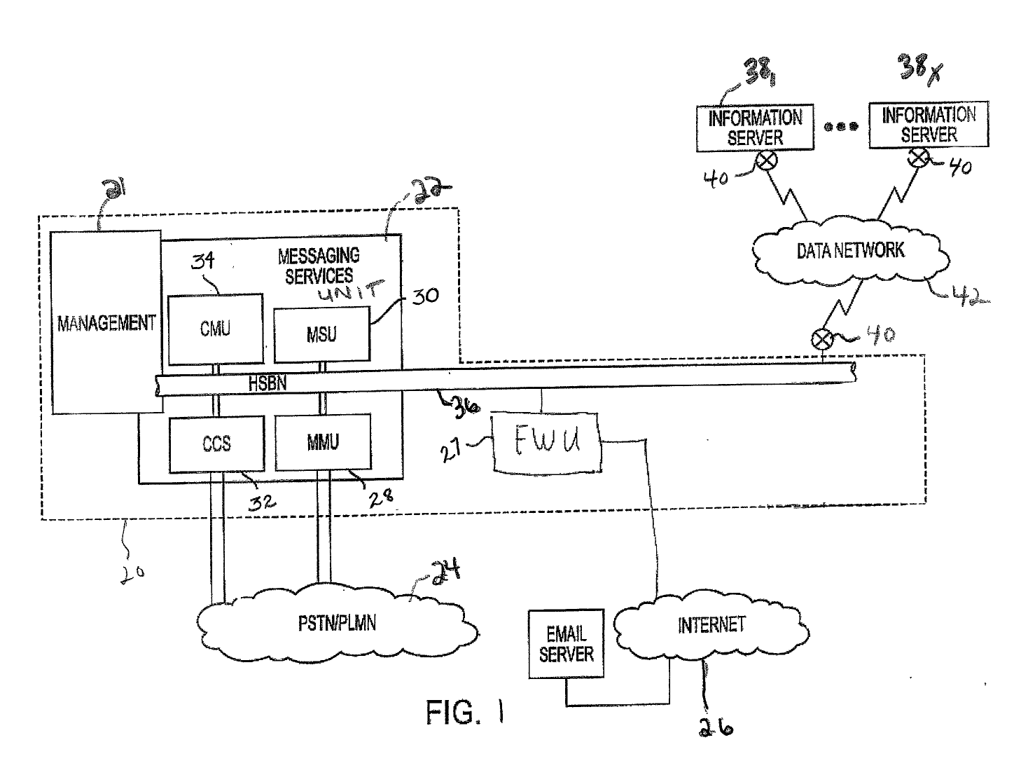

Although the present invention can be applied to many different types of voice controlled apparatus and communication systems, an example of an embodiment of the invention will be described in which the communication system is an information services, or enhanced services, system having a distributed architecture. A block diagram of an information server 20 (FIG. 1) is described below together with its connections to a public switched telephone network (PSTN) or public land mobile network (PLMN) 24 and sometimes to the Internet 26 via a firewall unit (FWU) 27.

FIG. 1 is a block diagram of an embodiment of information server 20 in which the features of the present invention may be used. In a preferred embodiment, the information server 20 is the TRILOGUE™ INfinity™ system from Comverse Network Systems, Inc. of Wakefield, Mass. However, it should be understood that the present invention is not limited to information servers, nor is it limited to information servers having the architecture illustrated in FIG. 1. Specifically, the invention may be employed in any voice controlled apparatus. For example, the features of the present invention may also be applied to the Access NP® system which is manufactured and sold by Comverse Network Systems, Inc. of Wakefield, Massachusetts.

Referring to the example of FIG. 1, the major components that may be included in the information server 20 include a management unit 21 and a messaging services unit 22 which provides voicemail and facsimile, as well as unified messaging services, such as e-mail and short message services. The short message service messages are conventionally communicated by cellular telephone networks in the PSTN/PLMN 24 or transmitted via a public data communications network such as the Internet 26.

The messaging services unit 22 is a voice controlled unit which is composed of a plurality of multi-media units (MMUs) 28 that are connected to voice trunks in the PSTN/PLMN 24, that perform voice signal processing functions in a plurality of messaging and storage units (MSUs) (and Natural Language Units (NLUs)) 30 that store the subscriber records and host application logic such as the Tel@GO™ personal assistant application. In addition, the MSUs 30 store various system and custom prompts which are used to activate the various functionality and services provided by the information server 20.

The MMUs 28 can be provided by computers controlled by single or multiple microprocessors, such as Pentium-based computers, manufactured by Comverse Network Systems, Inc. of Wakefield, Mass. with 1 MB memory, 4 GB system disk storage, network interface cards and voice processing cards. The MSU 30 is a similar computer having up to 18 GB additional storage for private subscriber information. A call control server (CCS) 32 interfaces with call signaling trunks, such as SS7, system message desk interface (SMDI), etc., in the PSTN/PLMN 24 to provide information on the calling number, etc. The CCS 32 may be a similar Pentium-based computer made by Ulticom Corp. of Mount Laurel, N.J. with network interface cards. Overall control of messaging services is performed by central management unit (CMU) 34 which is connected to the MMUs 28, the MSUs 30 and the CCS 32 by a high-speed backbone network (HSBN) 36, such as a switched Ethernet supporting 10 Base T and 100 base T. The CMU 34 may be an Alpha-based computer made by Compaq of Houston, Texas, with interfaces to the HSBN 36 as well as to a host management computer (not shown) of the network operator.

When a subscriber calls an information server, such as information server 20, the call reaches an MMU 28 which interacts with the subscriber record stored on the subscriber's home MSU 30. The information server 20 is also connected to other information servers 38₁ . . . 38ₓ via routers 40 and a data network 42. The CMU 34 performs address resolution to identify the home MSU 30 and communicates with CMUs in other information servers (for example, information servers 38₁ . . . 38ₓ). If the subscriber's call reaches an MMU 28 with his home MSU 30 located on the same information server 20, that is local access. If the home MSU 30 is located on another information server 38₁ . . . 38ₓ, this is considered remote access.

As described above, the messaging and storage units (MSUs) 30 are capable of playing any one of a number of individual audio passages to a user or subscriber in the form of prompts. These prompts are used with respect to a variety of different types of services which are provided by the information server 20. Such prompts invite a user to either enter keystrokes on the telephone or to provide a voice response. As described above, in the prior art, such inputs by users have often been the subject of confusion because the prompt does not clearly identify the appropriate response to be made by the user. The present invention overcomes the above problem by providing to the user a single audio voice passage (which may be a prompt), wherein the single audio voice passage has at least first and second different voices which invite a response from a user.

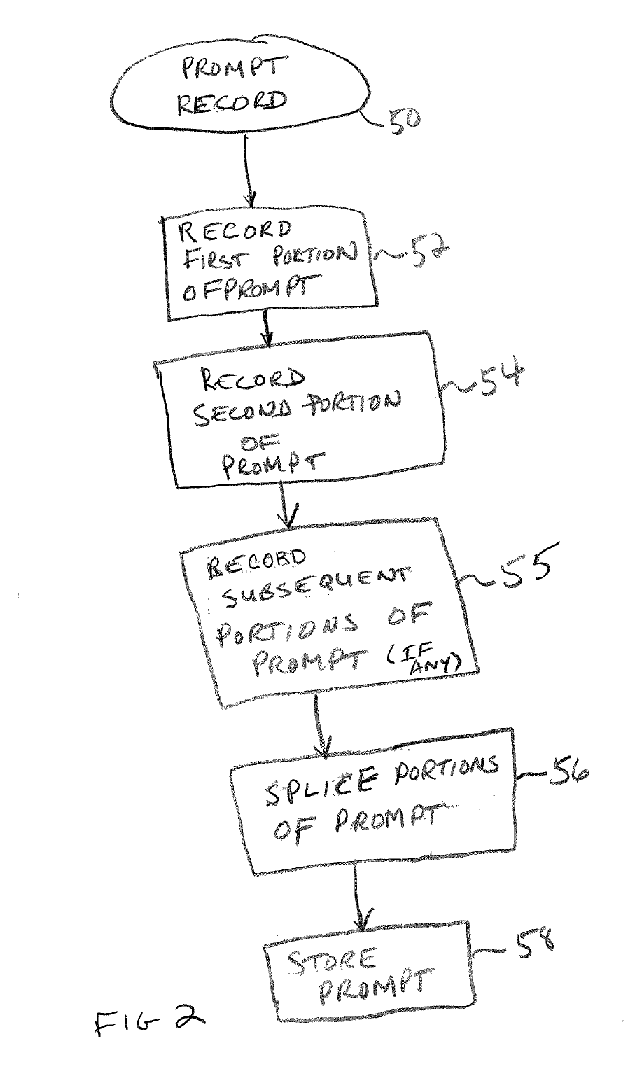

Using the example of the prompts for the information server 20 of FIG. 1, the process for recording a two voice prompt is illustrated by the flowchart of FIG. 2. Referring to FIG. 2, when recording of a prompt is to take place at 50, a first portion of the prompt is recorded at 52 with a first voice. Then a second portion of the prompt is recorded at 54 with a second voice which is different from the first voice. Then subsequent portions of the prompt (if any) are recorded at 55. After all portions of the prompt have been recorded then they are spliced together at 56 by using an audio editing software tool such as the Cool Edit software which is manufactured by Syntrillium Software Corporation of Scottsdale, Arizona. After the first and second portions of the prompt have been spliced together, the spliced prompt is stored at 58 in the MSU 30.

As an alternative, the portions of the prompt may be separately stored in the MSU 30 and then accessed and concatenated by the MSU 30 in order to play the two voices in a single prompt for a user. Such concatenation processes are widely used in voice messaging systems such as the TRILOGUE™ INfinity™ system and the Access NP® system, both of which are manufactured by Comverse Network Systems, Inc. of Wakefield, Mass.

Therefore, in the splicing method, two or more audio clips are spliced together. That is, each voice is recorded separately, and then the clips are filtered and spliced together so that the timing sounds natural. The audio clip can then be called by the appropriate program. One voice talent records prompts for one voice and another voice talent records prompts that are for a second voice. The prompts are then spliced together or stored for concatenation purposes. Alternatively, one voice talent can record in two different voices.

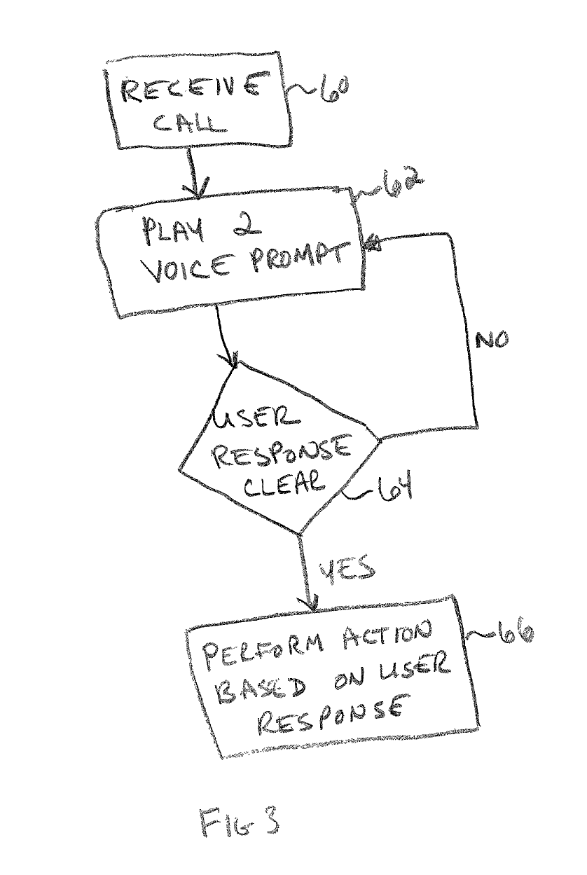

FIG. 3 is a flowchart which illustrates the process by which the MSU 30 plays a two voice prompt which has been spliced together based on the process of FIG. 2. Initially, the information server 20 receives a call at 60 and forwards the call to the appropriate MSU 30 as described above. At some point during the call, under the control of the MSU 30, a spliced together prompt having two voices is played at 62. The system then determines whether the user has provided an appropriate, or clear, response at 64. If a clear response has not been provided then the voice prompt is replayed at 62. If a clear response has been provided then the MSU 30 causes the appropriate action to be performed based on the user response at 66.

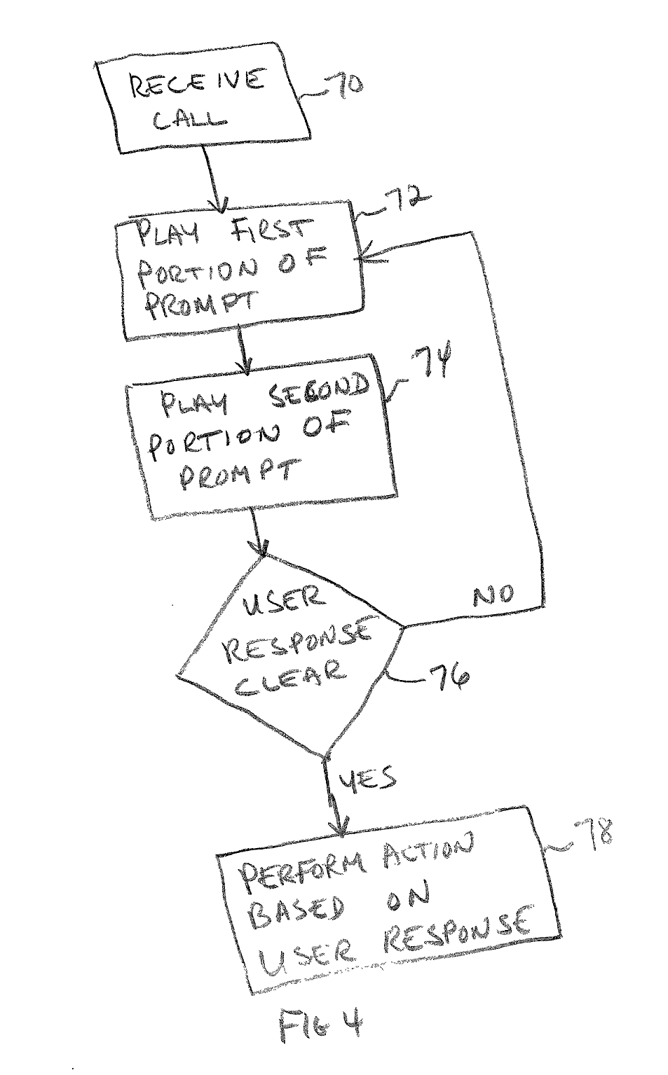

FIG. 4 is a flowchart which illustrates the process performed by the MSU 30 in accordance with the embodiment where two separately stored voice prompts are concatenated and played to a user. The call is received at 70 and routed to the MSU 30. The MSU 30 will access and play the first portion of the prompt at 72 and immediately concatenates and plays the second portion of the prompt at 74. It is then determined whether the user has provided a clear response at 76. If not, the two portions of the prompt are again concatenated and played for the user at 72 and 74. If a clear response is provided, then the MSU 30 causes the appropriate action to be performed based on the user response at 78.

While splicing the two prompts together provides a better quality prompt, the use of concatenation is much more flexible because it requires the recording of fewer separate prompts. This can be particularly important where it is possible that a prompt may continue to change, for example, with the day, date or season.

As described above, the present invention can be used in numerous applications. In addition to the personal assistant/voice mail applications described above, the features of the present invention can be used in any type of voice controlled apparatus for example, voice controlled apparatus for robots, manufacturing systems, robotic toys or automobiles. In addition, in a desktop computer, voice control can be used, for example, to indicate “open file” to open a file. The features of the present invention can be used in any product or method which is voice controlled.

Another application of the present invention is a gaming application. In the gaming situation, the system might say “now you can make a chess move” and a different voice would specify or suggest the move, “QUEEN, PAWN” in a different or softer voice.

In addition, the intonation or speed of the second voice which is used in the present invention may be used to specify urgency or to assist the user in responding to a prompt. The use of different intonation or accent may be especially helpful in voice recognition situations because the user will then be enticed to imitate the same intonation, thereby making it easier for the recognizer to recognize the spoken word. Thus, the quality and the speed of operation of the system may be improved by using a distinctive intonation on the second voice.

Another example of the use of the present invention is the use of VoiceXML which allows users who are using VoiceXML to create a voice webpage. A set of inputs and a set of outputs are defined and output prompts using the features of the invention are used to run scripts.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method comprising playing a single audio voice passage to a user, the single audio voice passage having at least first and second different voices which invite a response from the user.

2. A method as recited in claim 1, wherein the second voice indicates to the user the type of response which is invited from the user.

3. A method as recited in claim 1, wherein said at least first and second different voices are recorded from at least two different people.

4. A method as recited in claim 1, wherein the single audio voice passage is a voice prompt.

5. A method as recited in claim 4, wherein the voice prompt includes at least three segments.

6. A method as recited in claim 1, wherein the response which is invited from the user is a spoken response by the user.

7. A method as recited in claim 1, wherein the response invited from the user is a manual input response.

8. A method as recited in claim 7, wherein the manual input response is a key entry.

9. A method as recited in claim 1, wherein the second different voice has a distinctive intonation.

10. A voice controlled system comprising a voice controlled unit which plays a single audio voice passage to a user, the single audio voice passage having at least first and second different voices which invite a response from the user, said voice controlled unit receiving a response from the user.

11. A system as recited in claim 10, wherein said voice controlled unit is a messaging services unit.

12. A system as recited in claim 11, wherein said messaging services unit includes a personal assistant.

13. A system as recited in claim 11, wherein said messaging services unit includes a voice messaging unit.

14. A system as recited in claim 10, wherein said voice controlled system is an interactive voice response system.

15. A system as recited in claim 10, wherein the response which is invited from the user is a spoken response by the user.

16. A computer readable storage controlling a computer by playing a single audio voice passage to a user, the single audio voice passage having at least first and second different voices which invite a response from the user.

17. A computer readable storage as recited in claim 16, wherein the second voice indicates to the user the type of response which is invited from the user.

18. A computer readable storage as recited in claim 16, wherein the response which is invited from the user is a spoken response by the user.

19. A computer readable storage as recited in claim 16, wherein the response invited from the user is a manual input response.

20. A method comprising:
receiving a call from a caller;
in response to the call, playing a single audio passage to a user, the single audio passage having at least first and second different voices which invite a response from the user;
performing an action based on a response provided by the user.
